(19) United States
(12) Patent Application Publication
(10) Pub. No.: US 2020/0324346 A1
(43) Pub. Date: Oct. 15, 2020

(54) ANGLED ULTRASONIC MACHINING TOOL

(71) Applicant: Rolls-Royce plc, London (GB)

(72) Inventors: Michael J. Whittle, London (GB); Alistair Buchanan, London (GB); Craig A. Johnson, London (GB)

(21) Appl. No.: 16/382,942

(22) Filed: Apr. 12, 2019

(51) Int. Cl. B23B 37/00

(52) U.S. Cl. CPC B23B 37/00

(57) ABSTRACT

According to an aspect of this disclosure, an ultrasonic machining apparatus may include a machining head disposed at an angle, a machining platform for mounting a component, and one or more actuators for imparting ultrasonic vibration on the component wherein the angled machining head operates on the component according to the angle of the machining head, a position of the component, and the ultrasonic vibration.

### FIELD OF THE DISCLOSURE

The present disclosure relates generally to ultrasonic machining, and more specifically to machining of components for gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high-pressure air to the combustor. In the combustor, fuel is mixed with the high-pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, gas is propelled along a path through the gas turbine engine. Some components positioned in the turbine may be exposed to high temperatures from products of the combustion reaction in the combustor. Such components may be made from materials that have different characteristics, such as hardness, resilience, elasticity, brittleness, durability etc.

Harder and more heat resistant materials are being continually sought out and developed for fabrication of gas turbine engine components capable of withstanding the extreme conditions that are commonplace within a gas turbine engine. With increasing hardness and durability of component materials, comes increasing challenges in machining useful components using such materials. Ultrasonic vibration machining is known for the usefulness thereof in precisely machining hard materials. However, applications of ultrasonic machining are often performed with unwieldy straight machine heads.

The description provided in the background section should not be assumed to be prior art merely because it is mentioned in or associated with the background section. The background section may include information that describes one or more aspects of the subject technology.

### SUMMARY

The present disclosure may comprise one or more of the following features and combinations thereof.

According to an aspect of this disclosure, an ultrasonic machining apparatus may include a machining head disposed at an angle, a machining platform for mounting a component, and one or more actuators for imparting ultrasonic vibration on the component wherein the angled machining head operates on the component according to the angle of the machining head, a position of the component, and the ultrasonic vibration.

In some embodiments of the ultrasonic machining apparatus, the position of the component is determined by the machining platform and the machining platform is adjustable along at least five axes. Also in example embodiments of the ultrasonic machining apparatus, the machining head is adjustable to at least one other angle. Also in embodiments, the position of the angled machining head is 90 degrees. Further, in some embodiments of the ultrasonic machining apparatus the one or more actuators are disposed within the angled machining head. Still further embodiments of the apparatus may include that the one or more actuators are disposed about the machining platform. Additional embodiments of the ultrasonic machining apparatus have the one or more actuators develop ultrasonic vibrations in alignment with the angled machining head. Yet still further, the machining head of the apparatus is insertable within the component being machined. Also in embodiments of the apparatus the machining head, position of the component, and the ultrasonic vibration are coordinated by a controller.

According to another aspect of this disclosure, a machining method includes the steps of positioning a right-angled machining head, developing ultrasonic vibration, guiding the right-angled machining head to machine a component, and adjusting one of machining head position, component position, and ultrasonic vibration direction to align the translational motion of the right-angled machining head with the ultrasonic vibration.

In some embodiments of the machining method, the ultrasonic vibration is developed by one or more actuators. Also in example embodiments of the machining method, the component is disposed on a machining platform adjustable in three-dimensional space. According to other example embodiments, the one or more actuators are disposed along one or more sides of the machining platform. In further embodiments of the machining method, the adjusting of the machining head position, component position, and the ultrasonic vibration is coordinated by a controller. Still further, in examples of the machining method, the one or more actuators are disposed within the right-angled machining head.

According to yet another aspect of this disclosure, an angled machining system includes an angled machining head, a machining platform positionable within three-dimensional space, a plurality of actuators disposed about the machining platform for applying ultrasonic vibration to a component fixed to the machining platform, and a controller for executing motion of the machining platform and the angled machining head.

In some embodiments of the angled machining system, the motion of the machining platform and the angled machining head bring the component into contact with a machining bit driven by the angled machining head. Also in some embodiments, translational motion of the driven machining bit is coordinated with an axis of vibration. In further example embodiments, the axis of vibration is adjusted by activating a subset of the plurality of actuators. In still further examples of the angled machining system, the machining platform is positionable by and disposed upon a machining table that pivots and translates.

These and other features of the present disclosure will become more apparent from the following description of the illustrative embodiments.

### BRIEF DESCRIPTION OF THE DRAWINGS

FIG. 1 depicts a conventional straight machining apparatus;

FIG. 2 illustrates an angled machining apparatus;

FIG. 3 is a system for combining the angled machining apparatus and ultrasonic assistance;

FIG. 4A is a partial cross-sectional view, taken along line 4A-4A shown in FIG. 4B, of a full-hoop component with the angled machining apparatus operating therein;

FIG. 4B is an isometric view of the full-hoop component;

FIG. 5 is a partial cross-sectional view of a nozzle guide vane with the angled machining apparatus operating therein; and

FIG. 6 is an example non-metallic gas turbine engine component.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION OF THE DRAWINGS

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

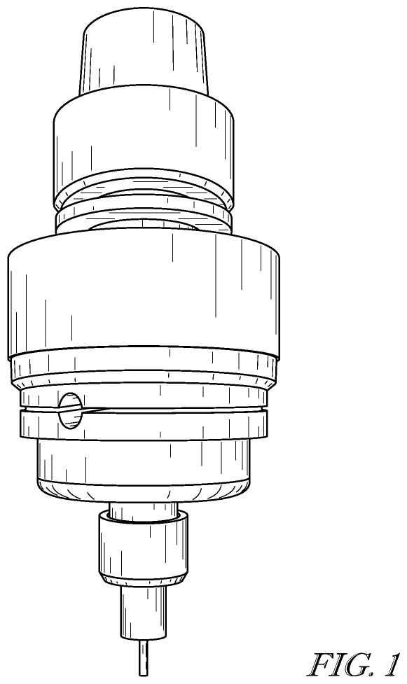

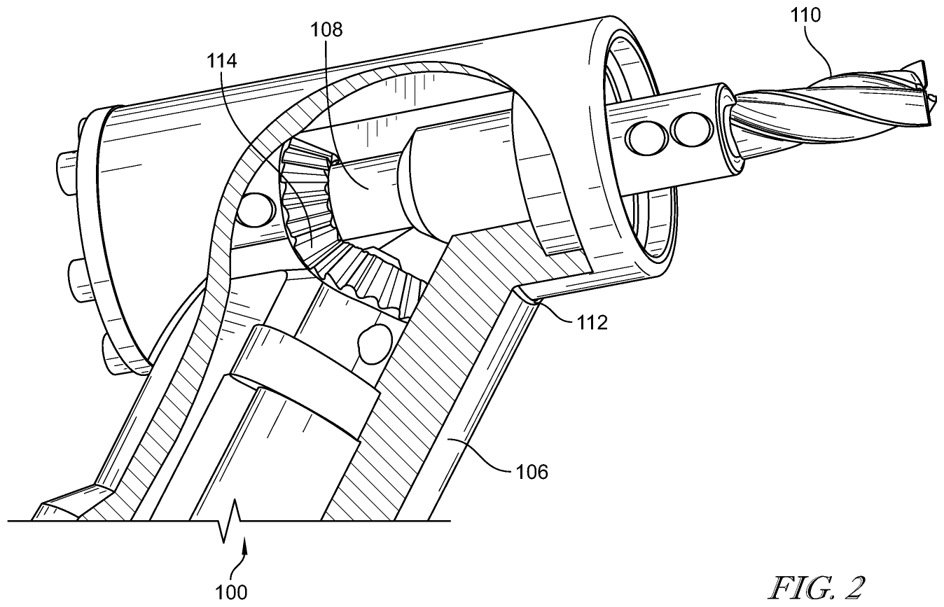

The present disclosure, with reference to FIGS. 2-5, describes a system and/or method 100 for machining one or more features on and/or within one or more machined component(s) 104 with ultrasonic assistance. FIG. 1 depicts a conventional straight machining apparatus having a driving mechanism and machining bit stacked one on top of the next and aligned vertically. Such a conventional machining apparatus is difficult to direct within and along components, particularly components that call for undercuts, features machined from within the component, and/or other features that are difficult to machine without a machining operational end passing through or within the component. The machining apparatus of FIG. 1 is a typical tool utilized in combination with ultrasonic assistance.

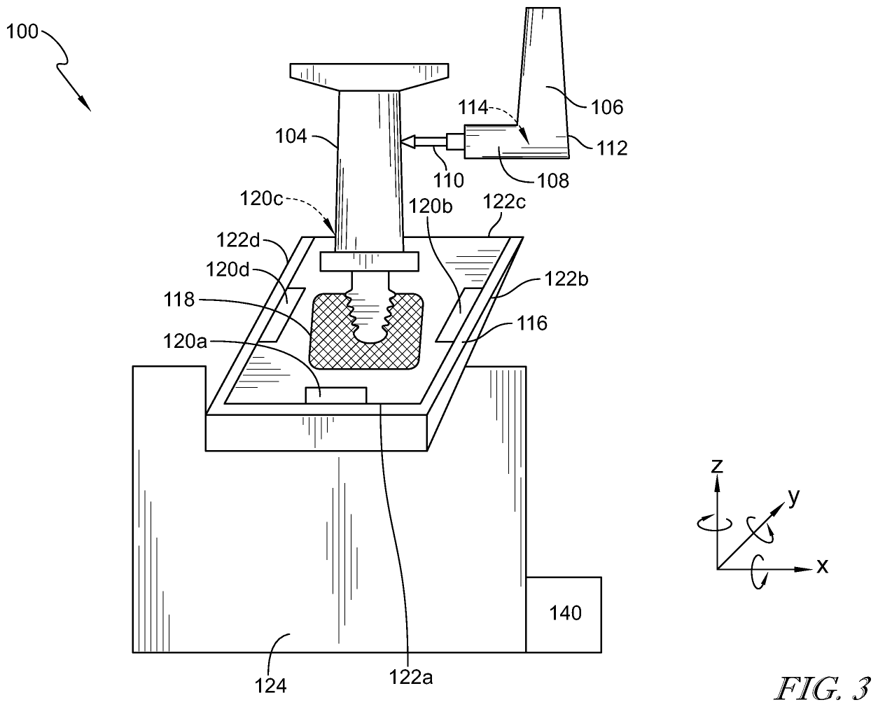

Referring now to FIGS. 2 and 3, the system 100 comprises a machining apparatus 106 and a machining platform 116. An angled machining head 108 of the machining apparatus 106 further comprises a machining bit 110 disposed at a terminus of an angled machining arm 112 wherein a machining drive mechanism 114 is disposed. In example embodiments of the system 100, the machining arm 112 is disposed at a right angle.

Ultrasonic assistance enables machining of materials exhibiting very high hardness characteristics such as ceramic matrix composites (CMC), diamond, dental materials, and/or other industrial materials for which machining is difficult due to material hardness. Further, right-angled machining facilitates access to portions of the machined component(s) 104 that would be otherwise inaccessible with conventional machining apparatuses. According to the embodiments of FIGS. 2-5, the system 100 combines qualities of the angled machining arm 112 with ultrasonic assistance. The system 100 is applicable, for example, to machining of CMC gas turbine engine components, high-hardness dental components, high-hardness manufacturing components, high-hardness jewelry, diamond drill bits, high-hardness materials used in the automobile industry, and/or other components and/or products manufactured from particularly hard materials. The system 100 is further applicable to the manufacture of items from high-hardness materials wherein the machining of intricate, delicate, and/or complex features is desired.

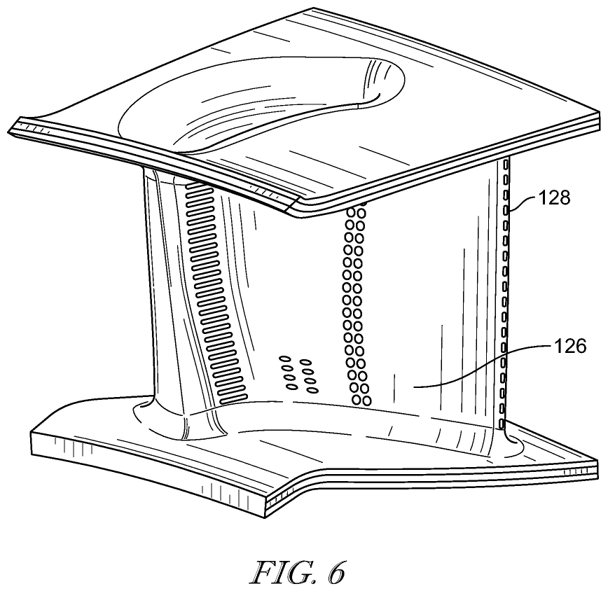

Referring now to FIG. 3, in an example embodiment, the machining apparatus 106, having the angled machining head 108, is suspended, mounted, and/or otherwise engaged with the component 104. As noted earlier, according to an example embodiment, the component 104 is a CMC gas turbine engine component (see also FIG. 6). The component 104 is disposed on a machining platform 116. The machining platform 116 may be and/or comprise a rig, mount, clamp, vice, and/or other suitable apparatus for mounting a component and imparting vibration to same. According to the example shown in FIG. 3, a mount 118 is disposed generally central on the machining platform 116.

The machining platform 116 comprises one or more actuators and/or transducers 120. The one or more actuators 120a, 120b, 120c, 120d are disposed, respectively, along sides 122a, 122b, 122c, 122d of the machining platform 116. The actuators 120 impart vibration, particularly ultrasonic vibration, to the component 104 by way of the machining platform 116. According to examples, the entire machining platform 116 is vibrated, the mount 118 alone is vibrated, and/or the component 104 alone is vibrated by the actuators 120. The actuators 120 are coordinated to provide vibration that is translated to the component 104 according to machining specifications particular to each application. A controller 140 coordinates the movement of the actuators 120 and the machining apparatus 106.

According to examples, a particular frequency of vibration may be desired for machining the component 104 when the component 104 is characterized by a certain hardness, Young's modulus, brittleness, elasticity, and/or another operative characteristic. Further, the particular frequency of vibration applied may be specified according to the size and/or shape of features to be machined. For example, relatively smaller features, shallower features, deeper features, larger features, and/or features having precise angles may call for application of differing frequencies. The actuators 120a-b also are independently operable, such that vibrations are applied at only one side. Alternatively, the actuators 120a-b are operable as subsets, comprising, for example, two opposed actuators, of the actuators 120a-b. According to an example, the opposed actuators 120b, 120d vibrate the component 104 and/or the entire machining platform 116 back and forth. According to examples, the ultrasonic vibration is aligned with the translational movement of the machining bit 110.

As discussed hereinabove, the actuators 120 are capable of applying vibrations in the x and y directions (as designated in FIG. 3). The actuators 120 are further capable of applying vibrations in the z direction (i.e., up and down, relative the present example). In examples, one or more additional actuators may be disposed beneath the machining platform 116 to provide additional vibration in the z direction. Further, the machining platform 116 is operatively coupled to an adjustable machining table 124. The adjustable machining table 124 enables 5-axis pivoting. For example, the adjustable machining table 124 may travel along the x and y directions, pivot in the x and y directions, and travel up/down travel in the z direction. Other alternative adjustable machining table configurations are contemplated hereby. In examples, spin and/or rotation may also be applied along one or more of the axes (as denoted in FIG. 3). Still further, the machining table 124 may also be adjustable along fewer axes, such as two or three axes, depending on the specifications of particular manufacturing applications.

Additionally, it is desirable to vibrate the component 104 along a plane that is aligned with the machining bit 110 of the machining head 108. Therefore, the ultrasonic vibration applied by the actuators 120 and the machining platform 116 is coordinated with the position of the machining head 108. Accordingly, the controller 140 tracks the platform 116 and the machining head 108 as same move through three-dimensional space and imposes vibrations such that the component 104 being machined always vibrates translationally with respect to the machining bit 110 (i.e., translational motion of the machining bit 110 is aligned with the axis of vibrational motion). In this example embodiment (FIG. 3), ultrasonic vibration and movement are applied to the component 104. As a result, the machining apparatus 106 is not subjected to the ultrasonic vibrations. This reduces the complexity and improves reliability of the system 100. The controller 140 comprises a memory module and one or more processors for executing software that tracks the movement of the elements discussed in this paper.

Referring ahead to FIG. 6, a nozzle guide vane 126 manufactured from CMC and suitable for deployment within the combustion stage of a gas turbine engine is illustrated. Vanes fabricated from CMC often utilize cooling methods to survive the harsh operating conditions of gas turbine engines. Ultrasonic assisted machining is a capable approach to machining trailing edge cooling holes 128 for cooling the vane 126.

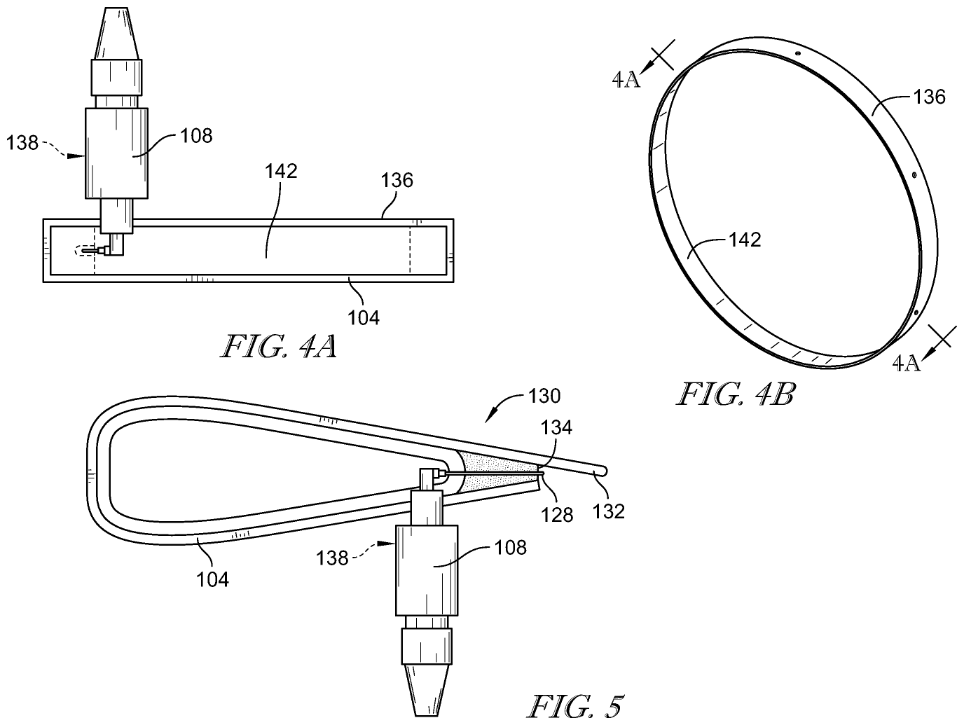

The trailing edge geometries of the vanes 126 and/or other airfoils are challenging to access for conventional machining tools (see FIG. 1). In example embodiments, as noted hereinabove, the angled machining head 108 utilized by the system 100 is a 90° machining head, although the machining head 108 may be disposed at a different angle or adjustable along a continuum of angles. The angled machining head 108 is applicable for machining turbine cases, as shown in FIGS. 4A and 4B, because the angled machining head 108 may be positioned interior to a full-hoop design turbine case 136 and remove material along an inside surface 142 thereof. The full-hoop design is often desirable for CMC components. The angled machining apparatus 106 enables access to the interior surface 142 of the full-hoop turbine case 136 while the system 100 applies ultrasonic assistance through the machining platform 116 to improve CMC machining performance. FIG. 4A depicts a cross-sectional view of the full-hoop CMC turbine case 136 of FIG. 4B with the angled machining head 108 shown operating within the annulus of the full-hoop design.

For example, the system 100 facilitates machining configurations such as a pressure side step architecture vane 130 shown in FIG. 5. The overlapping flap 132 of the pressure side step architecture vane 130 prevents a straight, conventional machine head from accessing a surface of the vane 130 from the exterior thereof. Thus, machining from within the vane 130 is utilized to create the cooling holes 128 through a trailing edge 134 thereof. As a result, constraints on the location and/or angle of trailing edge cooling holes 128 are overcome. Manufacture of the cooling holes 128 within the trailing edge 134 of the pressure side step architecture vane 130 reduces the consumption of cooling airflow and improves the stress state at the trailing edge.

According to an alternative embodiment, one or more actuators and/or transducers 138 are placed within the machining head 108 such that the angled machining head 108 is subject to the rotational and translational movements produced by a combination of the machining bit 110 and the one or more ultrasonic actuators 138, respectively. The one or more actuators 138 are disposed within the machining head 108 such that the size of the machining head 108 is minimized, and; therefore, is still easily insertable within the component(s) 104 (e.g., the pressure side step architecture vane 130 of FIG. 5).

The one or more ultrasonic actuators 138 also are designed to maintain acceptable machining tolerances for the machining bit 110. Vibrations outside of a certain range may result in machining outside of the intended area and imprecise removal of material from the component(s) 104. Additionally, certain components—particularly, full-hoop components fabricated from CMC—could utilize this example embodiment of the system 100 to form internal features of the hoops with ultrasonic vibration assistance. Conventional machining methods may not be able to reach certain portions of a full-hoop architecture that are currently very difficult to fabricate with accuracy.

The embodiment(s) detailed hereinabove may be combined in full or in part, with any alternative embodiment(s) described.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory.

Modules, steps, processes, controls, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An ultrasonic machining apparatus, comprising:
a machining head disposed at an angle;
a machining platform for mounting a component; and
one or more actuators for imparting ultrasonic vibration on the component;
wherein the angled machining head operates on the component according to the angle of the machining head, a position of the component, and the ultrasonic vibration.

2. The ultrasonic machining apparatus of claim 1, wherein the position of the component is determined by the machining platform and the machining platform is adjustable along at least five axes.

3. The ultrasonic machining apparatus of claim 2, wherein the machining head is adjustable to at least one other angle.

4. The ultrasonic machining apparatus of claim 2, wherein the position of the angled machining head is 90 degrees.

5. The ultrasonic machining apparatus of claim 4, wherein the one or more actuators are disposed within the angled machining head.

6. The ultrasonic machining apparatus of claim 4, wherein the one or more actuators are disposed about the machining platform.

7. The ultrasonic machining apparatus of claim 5, wherein the one or more actuators develop ultrasonic vibrations in alignment with the angled machining head.

8. The ultrasonic machining apparatus of claim 1, wherein the machining head is insertable within the component being machined.

9. The ultrasonic machining apparatus of claim 1, wherein the machining head, position of the component, and the ultrasonic vibration are coordinated by a controller.

10. A machining method, comprising:
positioning a right-angled machining head;
developing ultrasonic vibration;
guiding the right-angled machining head to machine a component; and
adjusting one of machining head position, component position, and ultrasonic vibration direction to align the translational motion of the right-angled machining head with the ultrasonic vibration.

11. The machining method of claim 10, wherein the ultrasonic vibration is developed by one or more actuators.

12. The machining method of claim 11, wherein the component is disposed on a machining platform adjustable in three-dimensional space.

13. The machining method of claim 12, wherein the one or more actuators are disposed along one or more sides of the machining platform.

14. The machining method of claim 13, wherein the adjusting of the machining head position, component position, and the ultrasonic vibration is coordinated by a controller.

15. The machining method of claim 11, wherein the one or more actuators are disposed within the right-angled machining head.

16. An angled machining system, comprising:
an angled machining head;
a machining platform positionable within three-dimensional space;
a plurality of actuators disposed about the machining platform for applying ultrasonic vibration to a component fixed to the machining platform; and
a controller for executing motion of the machining platform and the angled machining head.

17. The angled machining system of claim 16, wherein the motion of the machining platform and the angled machining head bring the component into contact with a machining bit driven by the angled machining head.

18. The angled machining system of claim 17, wherein translational motion of the driven machining bit is coordinated with an axis of vibration.

19. The angled machining system of claim 18, wherein the axis of vibration is adjusted by activating a subset of the plurality of actuators.

20. The angled machining system of claim 19, wherein the machining platform is positionable by and disposed upon a machining table that pivots and translates.
